(19) United States
(12) Patent Application Publication
(10) Pub. No.: US 2008/0000421 A1
(43) Pub. Date: Jan. 3, 2008

(54) METHOD AND APPARATUS FOR APPLYING COATING SOLUTION WITH BAR

(75) Inventors: Atsushi Ooshima, Haibara-gun (JP); Satoru Matsumoto, Haibara-gun (JP); Nobuyuki Sone, Haibara-gun (JP); Yasuhito Naruse, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/769,471

(22) Filed: Jun. 27, 2007

(30) Foreign Application Priority Data
Jun. 28, 2006 (JP) 2006-178169
Mar. 26, 2007 (JP) 2007-079902

(51) Int. Cl. B05D 1/28

(52) U.S. Cl. 118/695; 427/8

(57) ABSTRACT

The present invention provides a method for applying a coating solution with a bar, comprising the steps of: contacting a rotating coating bar with a lower surface of a continuously running web; discharging a coating solution toward the lower surface of the web from a coating solution discharging section positioned upstream of the coating bar in a web running direction to form a coating solution reservoir upstream of the coating bar; and applying the coating solution to the web via the coating solution reservoir, wherein the method for applying a coating solution with a bar includes a step of regulating a pressure of the coating solution reservoir depending on a running speed of the web.

### BACKGROUND OF THE INVENTION

1. Field of the Invention

The present invention relates to a method and apparatus for applying a coating solution with a bar, more particularly, to a method and apparatus which enables a stable application of a coating solution which has a large contact angle to a web at a high speed. Also, the present invention relates to a method and apparatus for applying a coating solution with a bar which enables a stable application of a coating solution at a high speed to a web having a low wettability to a coating solution and also to a web which has a large surface roughness and tends to generate an entraining air flow due to the roughness.

2. Description of the Related Art

Generally, lithographic printing plates are manufactured using a running band-shaped support medium of pure aluminum or aluminum alloy (hereinafter, referred to as a “web”), by graining at least one surface of the web and forming an anodic oxidized film on the grained surface of the web as needed. Onto the web surface on the grained side, a coating solution for a photosensitive layer (alternatively, a coating solution for a thermosensitive layer is sometimes used) is applied to form a photosensitive layer, and the photosensitive layer is dried, resulting in a manufacture of an original band-shaped plate for a photosensitive or thermosensitive lithographic printing plate. Thus, in manufacturing a lithographic printing plate, an apparatus for applying a coating solution with a bar is generally used to apply a coating solution to a web to form a coating film.

An apparatus for applying a coating solution with a bar usually includes: a coating bar which is brought in contact with a lower surface of a continuously running web and rotates in the same direction as the running direction of the web or in the opposite direction to the running direction of the web; and a coating solution discharging section which discharges a coating solution to form a reservoir of the coating solution upstream of the coating bar in the web running direction (hereinafter, simply referred to as a “upstream”), and discharges the coating solution from the reservoir toward the lower surface of the web (for example, see Japanese Patent Laid-Open No. 2002-192050).

### SUMMARY OF THE INVENTION

Meanwhile, as a running speed of a web, that is a coating speed, is increased, an entrained air film, which is a film of air entrained while the web is running, is formed on a web surface. The capture of an entrained air film into the coating solution reservoir easily causes coating defects such as cracks in a resulting coating film.

In particular, with using a coating solution which has a large contact angle to a web, a low wettability of the coating solution to the web tends to cause coating defects such as cracks in a resulting coating film when the web is set to run at a high speed. So, when a coating solution which has a large contact angle to a web is used, in order to avoid such defects, the web should be set to run in a low speed for applying the coating solution, which leads to a low production efficiency.

An application of a coating solution at a high speed of 60 m/min or more (a web running speed) for example, by using a web having a low wettability to a coating solution due to a large contact angle or a web which has a large surface roughness and tends to generate an entraining air flow due to the roughness, tends to cause coating defects such as cracks in a resulting coating film due to the generation of entraining air flow. The term “entraining air flow” as used herein means an air flow which is accompanied by the running of the web, and the entraining air flow disrupts a stable coating because the air flow disturbs a coating solution reservoir. The entraining air flow is likely generated on a rougher web surface at a higher coating speed.

In order to address the above problems, Japanese Patent Laid-Open No. 2003-126753 discloses an apparatus for applying a coating solution with a bar in which an excess coating solution is applied to a web by a contact with a bar for pre-coating at a former stage, and the solution is measured to a desired amount by a contact with a bar for measuring at a latter stage, in which the web is brought in contact with the measuring bar within 0.25 second after the contact with the pre-coating bar, so that a coating solution can be applied in a stable manner even to a web surface which has a large surface roughness.

Japanese Patent Laid-Open No. 2003-159560 discloses an apparatus for applying a coating solution with a bar in which an excess coating solution is applied to a web by a contact with a bar for pre-coating at a former stage, and the solution is measured to a desired amount by a contact with a bar for measuring at a latter stage, in which a ratio of an amount of a coating solution W1 after the contact with the bar for pre-coating to an amount of a coating solution W2 after the contact with the bar for measuring is set to be within a range of 0.8 or more and 4.0 or less, so that a coating solution can be applied in a stable manner even at a high speed.

However, actually, such a conventional method for applying a coating solution with a bar is not provided with an approach to prevent discontinuous coated solution when a coating solution having a large contact angle to a web is used, or a web which has a large surface roughness and a low wettability to a coating solution is used.

For example, Japanese Patent Laid-Open Nos. 2003-126753 and 2003-159560 disclose a method for applying a coating solution in a stable manner at a high speed to a web which has a rough surface, by using an apparatus for applying a coating solution with a bar which has a bar for pre-coating and a bar for measuring for measuring a coating solution at a latter stage, but in the case of an apparatus for applying a coating solution with a bar having only one bar for coating and measuring in which coating and measuring are conducted at one stage, actually a satisfying approach for achieving a stable coating has not been found yet. Thus, conventionally, in an apparatus for applying a coating solution with a bar having only one bar for coating and measuring, a coating solution has had to be applied at a low speed.

In addition, Japanese Patent Laid-Open Nos. 2003-126753 and 2003-159560 disclose an approach to apply a coating solution at a high speed to a web which has a rough surface, but does not provide any approach to apply a coating solution at a high speed to a web which has a rough surface and also a low wettability to the coating solution.

The present invention was made in view of the above situation, and one object of the present invention is to provide a method and apparatus for applying a coating solution with a bar which enables a stable application of a coating solution having a large contact angle to a web without causing any coating defects such as cracks in a resulting coating film at such a high speed that an entrained air film is formed on a surface of the web.

Also, another object of the present invention is to provide a method and apparatus for applying a coating solution with a bar which enables a stable application of a coating solution at a high speed to a web having a low wettability to a coating solution and a web which has a large surface roughness and tends to generate an entraining air flow, as well as to provide a film coated product and a planographic printing plate which are manufactured by using the method for applying a coating solution with a bar.

In order to achieve the above object, a first aspect of the present invention provides a method for applying a coating solution with a bar, including the steps of: contacting a rotating coating bar with a lower surface of a continuously running web; discharging a coating solution toward the lower surface of the web from a coating solution discharging section positioned upstream of the coating bar in a web running direction to form a coating solution reservoir upstream of the coating bar; and applying the coating solution to the web via the coating solution reservoir, wherein the method for applying a coating solution includes a step of regulating a pressure of the coating solution reservoir depending on a running speed of the web.

The inventors of the present invention has found that, in a method for applying a coating solution with a bar according to the present invention, an increased speed of application of a coating solution which has a low wettability to a web (a degree of spread of a coating solution) due to a large contact angle thereof does not cause any coating defects such as cracks in a resulting coating film when a pressure of a coating solution reservoir is increased. A coating bar which is used in the method for applying a coating solution with a bar may be a flat bar, a wire bar, or a roll bar.

According to the first aspect of the present invention, in a method for applying a coating solution with a bar, a pressure of a coating solution reservoir is regulated depending on a running speed of a web. That is, when a web runs in a higher speed for application of a coating solution, a reservoir of the coating solution is set to have an increased pressure. This enables a stable application of a coating solution which has a large contact angle to a web without causing any coating defects such as cracks in a resulting coating film even when the coating solution is applied at such a high speed that an entrained air film is formed on a surface of the web.

In order to achieve the above object, a second aspect of the present invention provides a method for applying a coating solution with a bar including: a step of contacting a rotating coating bar with a lower surface of a continuously running web; a step of discharging a coating solution toward the lower surface of the web from a coating solution discharging section positioned upstream of the coating bar in the web running direction to form a coating solution reservoir upstream of the coating bar; and a step of applying the coating solution to the web via the coating solution reservoir, wherein it includes a step of regulating a pressure of the coating solution reservoir to satisfy a formula: 0.5V≦50+P−θ, where V is a running speed of the web in m/min, P is a pressure of the coating solution reservoir in kPa, and θ is a contact angle of a liquid on a solid of the coating solution in degrees.

The second aspect adds a relationship between three factors which includes a contact angle of a liquid on a solid of the coating solution in addition to a running speed of the web and a pressure of the coating solution reservoir, to avoid coating defects such as cracks in a resulting coating film. A pressure of a coating solution reservoir is regulated so that the three factors satisfy the above formula: 0.5V≦50+P−θ, resulting in that a coating solution which has a large contact angle to a web can be applied at a high speed without causing any cracks in a resulting coating film.

In order to achieve the above object, a third aspect of the present invention provides a method for applying a coating solution with a bar, including the steps of: contacting a rotating coating bar with a lower surface of a continuously running web; discharging a coating solution toward the lower surface of the web from a coating solution discharging section positioned upstream of the coating bar in a web running direction to form a coating solution reservoir upstream of the coating bar; and applying the coating solution to the web via the coating solution reservoir, wherein the method for applying a coating solution with a bar further includes a step of regulating a pressure of the coating solution reservoir to satisfy a formula: 0.5V≦40+P−50 Ra, where V is a running speed of the web in m/min, P is a pressure of the coating solution reservoir in kPa, and Ra is a surface roughness of the lower surface of the web in μm.

The third aspect of the present invention defines a condition for applying a coating solution in a stable manner at a high speed to a web surface which has a large surface roughness.

According to the third aspect of the present invention, in the method for applying a coating solution with a bar, a pressure of the coating solution reservoir is regulated to satisfy the above formula: 0.5V≦40+P−50Ra, which enables a stable application of a coating solution without causing any coating defects such as cracks in a resulting coating film even when a coating solution is applied at a high speed to a web surface which has a large surface roughness.

In order to achieve the above object, a fourth aspect of the present invention provides a method for applying a coating solution with a bar, including the steps of: contacting a rotating coating bar with a lower surface of a continuously running web; discharging a coating solution toward the lower surface of the web from a coating solution discharging section positioned upstream of the coating bar in a web running direction to form a coating solution reservoir upstream of the coating bar; and applying the coating solution to the web via the coating solution reservoir, wherein the method for applying a coating solution with a bar further includes a step of regulating a pressure of the coating solution reservoir to satisfy a formula: 0.5V≦90+P−θ−50Ra, where V is a running speed of the web in m/min, P is a pressure of the coating solution reservoir in kPa, θ is a contact angle of a liquid on a solid of the coating solution in degree, and Ra is a surface roughness of the lower surface of the web in μm.

The fourth aspect of the present invention defines a condition for applying a coating solution in a stable manner at a high speed to a web surface which has a large surface roughness as described above and a low wettability to the coating solution.

According to the fourth aspect of the present invention, in the method for applying a coating solution with a bar, a pressure P of the coating solution reservoir is regulated to satisfy the above formula: 0.5V≦90+P−θ−50Ra, which enables a stable application of a coating solution without causing any coating defects such as cracks in a resulting coating film even when a coating solution is applied at a high speed to a web surface which has a large surface roughness and a low wettability to the coating solution.

A fifth aspect of the present invention provides the method for applying a coating solution with a bar according to any one of the first to fourth aspects, wherein the running speed of the web V is 60 or more in m/min.

The fifth aspect of the present invention is defined because the effect of the present invention is further enhanced at a high speed where the running speed of the web V is 60 or more in m/min.

A sixth aspect of the present invention provides the method for applying a coating solution with a bar according to any one of the first to fifth aspects, wherein the pressure of the coating solution reservoir is regulated by changing a volume of the coating solution reservoir.

The sixth aspect provides a preferable way to regulate a pressure of a coating solution reservoir in which the pressure of the coating solution reservoir is regulated by changing a volume of the coating solution reservoir.

In order to apply a coating solution at a high speed in a stable manner to a web surface which has a large surface roughness and also a low wettability to a coating solution, usually, a pressure of a coating solution reservoir is regulated to be increased.

A seventh aspect of the present invention provides the method for applying a coating solution with a bar according to any one of the first to fifth aspects, wherein the pressure P of the coating solution reservoir is regulated by changing a volume of the coating solution which is discharged from the coating solution discharging section.

The seventh aspect provides another preferable way to regulate a pressure of a coating solution reservoir in which the pressure of the coating solution reservoir is regulated by changing a volume of the coating solution which is discharged from the coating solution discharging section. That is, a larger volume of the coating solution is discharged from the coating solution discharging section to increase a pressure of a coating solution reservoir. A pressure of a coating solution reservoir may be regulated both by changing a volume of a coating solution which is discharged from the coating solution discharging section and by changing a volume of a coating solution reservoir.

An eighth aspect of the present invention provides a method for manufacturing a coating film product wherein it includes a step of manufacturing a coating film product using the method for applying a coating solution with a bar according to any one of the first to seventh aspects.

A method for applying a coating solution with a bar according to any one of the first to seventh aspects enables an application of a coating solution at a high speed without causing any coating defects such as cracks in a resulting coating film and enhances productivity, which results in a coating film product with high quality and low price. Moreover, even if a web has a low wettability to a coating solution or, a large surface roughness, the present invention can provide a good coating film product without causing any coating defects such as cracks.

A ninth aspect of the present invention provides the coating film product according to the eighth aspect, wherein the coating film product is a lithographic printing plate which has a photosensitive layer thereon as a coating film.

Since a lithographic printing plate is generally manufactured using a method for applying a coating solution with a bar, the present invention is particularly useful in manufacturing a lithographic printing plate.

However, the present invention is not limited to the manufacture of a lithographic printing plate, and may be used in manufacturing other coating film products including photosensitive materials such as photographic films, magnetic recording materials such as recording tapes, thin painted metal sheets such as color steel sheet iron, and the like. Therefore, the webs to be applied with a coating solution may include, in addition to the webs described above, continuous band-shaped flexible substrates formed of metals, plastics, or paper, such as a lithographic printing original plate web having a photosensitive or thermosensitive engraving surface which is formed on a bandfiled side of a web, a substrate for a photographic film, coating bar writing paper for photographic paper, a substrate for recording tape, a substrate for a video tape, and a substrate for a floppy™ disc. The coating solution may be any solution which is applied to a web and dried to form a coat, and specifically may include: in addition to a coating solution for photosensitive layers and a coating solution for thermosensitive layers, a middle layer coating solution which improves adhesion of an engraving layer by forming a middle layer on a web surface, a polyvinyl alcohol aqueous solution used in forming an anodic oxidized film which protects an engraving surface of a lithographic printing original plate web from oxidation, a photosensitive colloid solution which is used in forming a photosensitive layer in a photographic film, a photosensitive colloid solution for sensitive papers which is used in forming a photosensitive layer of sensitive paper, a solution for forming a magnetic layer which is used in forming a magnetic layer of a recording tape, a video tape, or a floppy disc, and other various coating materials which are used in coating metals.

In order to achieve the above object, a tenth aspect of the present invention provides an apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, wherein it includes: a running speed measuring device for measuring a running speed of the web; a pressure measuring device for measuring a pressure of the coating solution reservoir; and a pressure regulating device for regulating the pressure of the coating solution reservoir measured by the pressure measuring device based on a measurement result by the running speed measuring device.

The tenth aspect embodies the present invention as an apparatus, in which a running speed is measured by a running speed measuring device, a pressure of a coating solution reservoir is measured by a pressure measuring device, and the pressure of the coating solution reservoir is regulated by the measured values so that even a coating solution having a large contact angle to a web can be applied at a high speed without causing any coating defects such as cracks in a resulting coating film.

An eleventh aspect of the present invention provides the apparatus for applying a coating solution with a bar according to the tenth aspect, wherein it further includes a contact angle measuring device for measuring a contact angle of the coating solution at the point of time (0 to 10 ms) when the coating solution contacts the web, and the pressure regulating device regulates the pressure of the coating solution reservoir so that the pressure satisfies a formula: 0.5V≦50+P−θ, where V is a running speed of the web measured by the running speed measuring device in m/min, P is a pressure of the coating solution reservoir measured by the pressure measuring device in kPa, and θ is a contact angle of a liquid on a solid of the coating solution which is measured by the contact angle measuring device in advance.

The eleventh aspect defines a preferable formula to regulate a pressure of a coating solution reservoir using a pressure regulating device when a contact angle of a coating solution is taken in account, and a regulation of the pressure of a coating solution reservoir to satisfy the above formula, 0.5V≦50+P−θ, allows even a coating solution having a large contact angle to a web to be applied at a high speed without causing any coating defects such as cracks in a resulting coating film.

In order to achieve the above object, a twelfth aspect of the present invention provides an apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, wherein the apparatus further includes: a running speed measuring device for measuring a running speed of the web; a pressure measuring device for measuring a pressure of the coating solution reservoir; a surface roughness measuring device for measuring a surface roughness of the lower surface of the web; and a pressure regulating device for regulating the pressure of the coating solution reservoir measured by the pressure measuring device based on the measurement results measured by the running speed measuring device and the surface roughness measuring device.

The twelfth aspect embodies the present invention as an apparatus, in which a running speed is measured by a running speed measuring device, a pressure of a coating solution reservoir is measured by a pressure measuring device, a surface roughness of the web is measured by a surface roughness measuring device, and the pressure of the coating solution reservoir is regulated based on the measured values, so that a coating solution can be applied at a high speed to a web surface having a large surface roughness in a stable manner without causing any coating defects such as cracks in a resulting coating film.

A thirteenth aspect of the present invention provides the apparatus for applying a coating solution with a bar according to the twelfth aspect, wherein the pressure regulating device regulates the pressure P of the coating solution reservoir so that the pressure P satisfies a formula: 0.5V≦40+P−50Ra, where V is a running speed of the web in m/min, P is a pressure of the coating solution reservoir in kPa, and Ra is a surface roughness of the lower surface of the web in μm.

The thirteenth aspect of the present invention shows a way to regulate a pressure of a coating solution reservoir by using a pressure regulating device, and in the sixteenth aspect, the pressure P of the coating solution reservoir is regulated so that the pressure P satisfies a formula: 0.5V≦40+P−50Ra.

A fourteenth aspec t of the present invention provides the apparatus for applying a coating solution with a bar according to the thirteenth aspect, wherein a formula θ≦50 is satisfied, where θ is a contact angle of a liquid on a solid of the coating solution in degree.

The fourteenth aspect of the present invention is defined because the above formula: 0.5V≦40+P−50Ra is more effective when the formula θ ≦50 degrees is satisfied.

In order to achieve the above object, a fifteenth aspect of the present invention provides an apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, wherein the apparatus further includes: a running speed measuring device for measuring a running speed of the web; a pressure measuring device for measuring a pressure of the coating solution reservoir; a surface roughness measuring device for measuring a surface roughness of the lower surface of the web; a contact angle measuring device for measuring a contact angle of the web to the coating solution at the point of time (0 to 10 ms) when the coating solution contacts the web; and a pressure regulating device for regulating the pressure of the coating solution reservoir measured by the pressure measuring device based on the measurement results measured by the running speed measuring device, the surface roughness measuring device, and the contact angle measuring device.

The fifteenth aspect embodies the present invention as an apparatus, in which a running speed is measured by a running speed measuring device, a pressure of a coating solution reservoir is measured by a pressure measuring device, a surface roughness of the web is measured by a surface roughness measuring device, a contact angle of the web to the coating solution is measured by a contact angle measuring device, and the pressure of the coating solution reservoir is regulated based on the measured values, so that a coating solution can be applied at a high speed to a web surface having a large surface roughness and a low wettability to the coating solution, in a stable manner without causing any coating defects such as cracks in a resulting coating film.

A sixteenth aspect of the present invention provides the apparatus for applying a coating solution with a bar according to the fifteenth aspect, wherein the pressure regulating device regulates the pressure of the coating solution reservoir so that the pressure satisfies a formula: 0.5V≦90+P−θ−50Ra, where V is a running speed of the web in m/min, P is a pressure of the coating solution reservoir in kPa, θ is a contact angle of a liquid on a solid of the coating solution in degree, and Ra is a surface roughness of the lower surface of the web in μm.

The sixteenth aspect of the present invention shows a way to regulate a pressure of a coating solution reservoir by using a pressure regulating device, and in the nineteenth aspect, the pressure P of the coating solution reservoir is regulated so that the pressure P satisfies a formula: 0.5V≦90+P−θ−50Ra.

According to a method and apparatus for applying a coating solution with a bar of the present invention, a stable application of a coating solution to a web can be achieved at such a high speed that an entraining air film may be formed on a web surface, without causing any coating defects such as cracks in a resulting coating film, even when the coating solution has a large contact angle to the web.

According to the present invention, a stable application of a coating solution to a web at a high speed can be achieved even when the web has a low wettability to the coating solution, or has a large surface roughness which tends to generate an entraining air flow.

Thus, a use of a method and apparatus for applying a coating solution with a bar of the present invention provides a film coated product and a planographic printing plate which do not have any coating defects such as cracks in the coated film.

### BRIEF DESCRIPTION OF THE DRAWINGS

FIG. 1 is a perspective view schematically showing an apparatus for applying a coating solution with a bar according to the present invention;

FIG. 2 is a cross sectional view showing a first embodiment of an apparatus for applying a coating solution with a bar according to the present invention;

FIG. 3 is a partially enlarged view mainly illustrating a coating solution discharging section of an apparatus for applying a coating solution with a bar according to the present invention;

FIG. 4A and 4B are views illustrating an application mechanism of an apparatus for applying a coating solution with a bar according to the present invention;

FIG. 5 is a cross sectional view showing a second embodiment of an apparatus for applying a coating solution with a bar according to the present invention;

FIG. 6 is a graph illustrating contact angles of a liquid on a solid θ of coating solutions;

FIG. 7 is a cross sectional view showing a third embodiment of an apparatus for applying a coating solution with a bar according to the present invention;

FIG. 8 is a cross sectional view showing a fourth embodiment of an apparatus for applying a coating solution with a bar according to the present invention;

FIG. 9 is a graph illustrating a test result in Example 1 of the present invention in which a coating solution having a contact angle of a liquid on a solid θ of 40 (degrees) is used;

FIG. 10 is a graph illustrating a test result in Example 1 of the present invention in which a coating solution having a contact angle of a liquid on a solid θ of 50 (degrees) is used;

FIG. 11 is a graph illustrating a test result in Example 1 of the present invention in which a coating solution having a contact angle of a liquid on a solid θ of 65 (degrees) is used;

FIG. 12 is a graph illustrating a test result in Example 1 of the present invention in which a coating solution having a contact angle of a liquid on a solid θ of 70 (degrees) is used;

FIG. 13 is a graph illustrating a test result in Example 2 of the present invention;

FIG. 14 is a graph illustrating a test result in Example 3 of the present invention; and

FIG. 15 is a graph illustrating a test result in Example 4 of the present invention.

### DETAILED DESCRIPTION OF THE PREFERRED EMBODIMENTS

### First Embodiment

Now, preferable embodiments of a method and apparatus for applying a coating solution with a bar according to the present invention will be explained below.

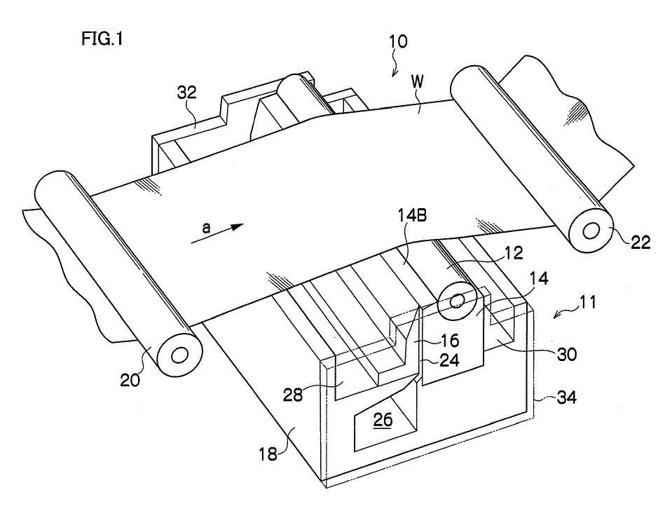

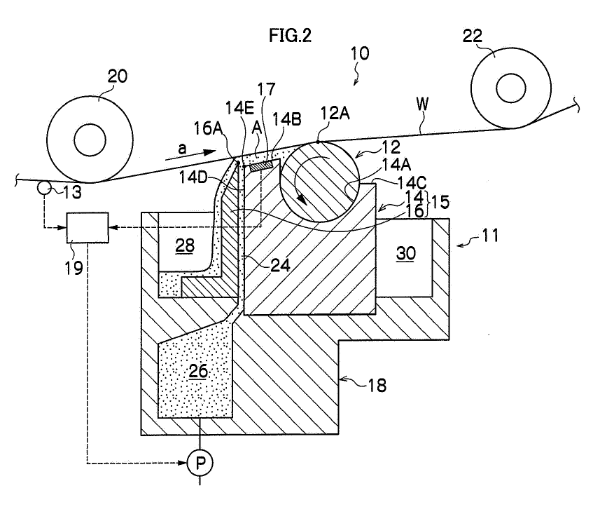

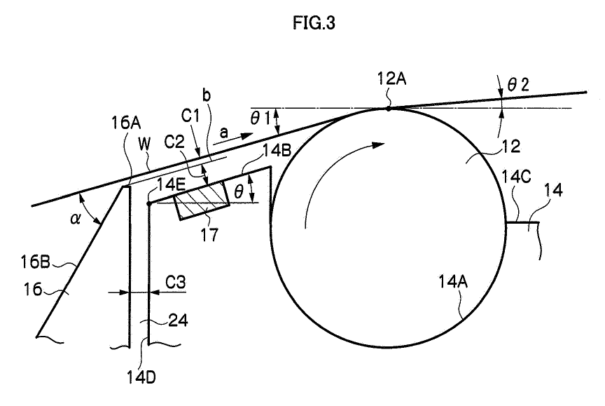

FIG. 1 and FIG. 2 are views showing a structure of a first embodiment of an apparatus for applying a coating solution with a bar according to the present invention. FIG. 3 is a view mainly showing a structure of a coating solution discharging section. FIG. 1 and FIG. 3 are commonly referenced by first to fourth embodiments which will be explained below.

As shown in FIG. 1 and FIG. 2, an apparatus for applying a coating solution with a bar 10 is an apparatus for applying a coating solution to a lower surface of a running web W, and generally includes a main body of the apparatus 11, a running speed measuring device 13 for measuring a running speed of the web W (see FIG. 2), a pressure measuring device 17 for measuring a pressure of a coating solution reservoir A (see FIG. 2), and a pressure regulating device 19 for regulating a pressure of the coating solution reservoir A measured by the pressure measuring device 17 based on a measurement result by the running speed measuring device 13 (see FIG. 2).

The main body of the apparatus 11 includes a coating bar 12, a coating solution discharging section 15 which mainly includes a bar supporting member 14 for supporting the coating bar 12 and a shuttering board 16, and a base 18. The web W is wound on pass rollers 20 and 22, and runs in a direction shown by an arrow a.

The coating bar 12 is formed in a cylindrical shape, and is rotatably supported by the bar supporting member 14. The coating bar 12 rotates about an axis thereof in contact with a lower surface of the running web W. The coating bar 12 preferably rotates in a direction which is opposite to the direction a in which the web W is running, and is set to rotate at a peripheral speed equal to 1% or less of the running speed of the web W. However, the coating bar 12 may rotate in the same direction as that of the running direction a.

The coating bar 12 may have a surface of a smooth flat bar, a rolling bar in which grooves are regularly formed around the circumferential surface thereof, or a wire bar in which wires are closely wound. When the coating bar 12 of a wire bar type is used, it preferably uses wires having a diameter of 0.07 to 1 mm, more preferably a diameter of 0.07 to 0.4 mm. When the coating bar 12 of a rolling bar type or a wire bar type is used, a reduced depth of grooves or a reduced diameter of wires allows a coating solution to be formed to have a smaller thickness, and an increased depth of grooves or an increased diameter of wires allows a coating solution to be formed to have a larger thickness.

The coating bar 12 preferably has a diameter of 6 to 25 mm from the viewpoint of manufacturing, and also the coating bar 12 having a diameter of 6 to 25 mm is preferable for it generally does not produce streaks in the longitudinal direction of the coating film of the coating solution formed on the web W. The coating bar 12 usually has a length larger than a width of the web W, but may have a length which is equal to a width of the web W.

The web W is set to be in contact with the coating bar 12 under tension at a predetermined wrap angle. As shown in FIG. 3, the web W upstream of the coating bar 12 is preferably set to have an angle θ1 relative to a horizontal plane (angle of approach) of 3 to 30 degrees, more preferably 5 to 10 degrees. This setting of the angle of approach θ1 can prevent a thick application of a coating solution at the start point and the end point of a coating, and also can restrain wearout of the coating bar 12. The web W downstream of the coating bar 12 is set to have an angle θ2 relative to a horizontal plane (angle of ejection) which is not limited to any value, but is set so that a wrap angle which is calculated from θ1 and θ2 has a predetermined value.

The bar supporting member 14 is configured by combining a plurality of blocks, and has an upper surface having an arc-shaped groove 14A formed therein. The coating bar 12 is engaged in the groove 14A to be rotatably supported therein. The bar supporting member 14 has a top surface 14B upstream of the groove 14A in the running direction a of the web W (hereinafter, simply referred to as upstream) which inclines relative to the horizontal plane. The top surface 14B preferably is formed to have an inclination angle θ which is generally equal to the angle of approach θ1 of the web 12. The bar supporting member 14 also has a horizontal top surface 14C downstream of the groove 14A in the running direction a of the web W (hereinafter, simply referred to as downstream). The top surface 14C is formed at a lower position than that of the top surface 14B. The bar supporting member 14 has a vertical wall surface 14D formed upstream, and the shuttering board 16 is displaced facing to the vertical wall surface 14D upstream of the vertical wall surface 14D.

The shuttering board 16 is a vertical plate member, and is fixed to the base 18 at a lower end thereof. The shuttering board 16 has a wedge-shaped upper (tip) end 16A which is linearly formed in the width direction of the web W and preferably has a parallel degree of 0.01 mm to 0.2 mm. A smaller parallel degree provides a larger effect which will be explained below, but also increases a manufacturing cost, so the parallel degree of 0.01 mm or more is preferable, and the parallel degree of 0.05 mm or more is more preferable.

The shuttering board 16 has the upper end 16A preferably at a lower position than that of the uppermost position 12A of the coating bar 12, and also more preferably at a higher position than that of an upstream upper end 14E of the top surface 14B. In this case, based on a parallel line b which is parallel to the web W and passes the top end 16A of the shuttering board 16, it is preferable that C1 and C2 satisfy a formula: 0.2≦C1/C2≦5, where C1 is the distance from the web W to the parallel line b and C2 is the distance from the parallel line b to the top surface 14B of the bar supporting member 14. However, it is preferable that C1 is not less than 0.1 mm because the web W may get scratches by contacting the top end 16A of the shuttering board 16 with fine vibrations and like on the web W, when C1 is too narrow. In addition, the formula: 0.2≦C1/C2≦5 must be satisfied through the shuttering board 16 and the entire area of the top surface 14B of the bar supporting member 14.

The shuttering board 16 is displaced parallel to the wall surface 14D of the bar supporting member 14 at a predetermined gap C4 from the wall surface 14D, thereby a slit-like supply flow path 24 is formed between the shuttering board 16 and the wall surface 14D. The gap C4 of the supply flow path 24 is preferably formed to be narrow in order to increase a pressure thereof without changing a volume of a coating solution to be supplied.

The supply flow path 24 is in communication with a temporarily storing chamber 26 which is provided in the base 18. The temporarily storing chamber 26 is connected to a discharging side of a pump P which supplies a coating solution from a coating solution storing tank (not shown), and a driving of the pump P causes the coating solution to be supplied to the temporarily storing chamber 26.

The temporarily storing chamber 26 functions to temporarily store a supplied coating solution therein, and to restrain any change of a flow rate of the coating solution which is supplied through the supply flow path 24 when a volume of the coating solution discharged from the pump P is changed. The coating solution supplied to the temporarily storing chamber 26 flows from a bottom end toward a top end of the supply flow path 24 to be discharged toward the web W from the discharge port at the top end of the supply flow path 24. This configuration defines a space for a coating solution reservoir A surrounded by the lower surface of the web W, the top surface 14B of the bar supporting member 14, the coating bar 12, and the shuttering board 16. The coating solution in the coating solution reservoir A is attached to the lower surface of the web W, and the excess coating solution attached to the lower surface of the web W is scraped off by the coating bar 12, so that the coating solution is adequately applied to the lower surface of the web W.

As shown in FIG. 2, the base 18 has a reservoir for overflow solution 28 upstream of the shuttering board 16, thereby the reservoir for overflow solution 28 receives the coating solution which overflows upstream over the top end 16A of the shuttering board 16. The base 18 also has a reservoir for overflow solution 30 downstream of the bar supporting member 14, thereby the reservoir for overflow solution 30 receives a part of the coating solution in the coating solution reservoir A which overflows downstream without being attached to the web W. The coating solution received in the reservoirs for overflow solution 28 and 30 is preferably returned to the storing tank (not shown) via a returning piping (not shown).

As shown in FIG. 1, the base 18 has side plates 32 and 34 at both ends thereof, and the side plates 32 and 34 provide side walls of the reservoirs for overflow solution 28 and 30, side walls of the supply flow path 24, and side walls of the temporarily storing chamber 26.

The above described base 18 is supported by a lifting device (not shown) to be movable in its height direction. Therefore, a movement of the base 18 by the lifting device can cause the coating bar 12 to be advanced toward the web W (upward) to be in contact with the web W, and to be retracted from the web W (downward) to be off from the web W. Instead of the movement of the base 18, movements of pass rollers 20, 22 in the height direction thereof may be used to change the position where the web W runs.

As shown in FIG. 2, the apparatus for applying a coating solution with a bar 10 further includes the running speed measuring device 13 for measuring a running speed (m/min) of the web W. The running speed measuring device 13 may be configured to have a tachometer which contacts the web W and rotates at a same speed as the web W so that the number of rotations of the tachometer can be converted into a running speed (m/min) of the web W by a calculator. When a feed roller is used to cause the web W to run, the number of rotations of the feed roller may be calculated into a running speed (m/min) of the web W. However, the running speed measuring device 13 is not limited to the above examples, and may have any configuration as far as a running speed (m/min) of the web W can be measured.

The pressure measuring device 17 for measuring a pressure (kPa) of the coating solution reservoir A may be, for example as shown in FIG. 2, a high-precision pressure sensor incorporated into the bar supporting member 14 at a position where the pressure sensor shares a plane common with the top surface 14B of the bar supporting member 14. However, the pressure measuring device 17 is not limited to the above example, and may be other element such as a manometer as far as a pressure (kPa) of the coating solution reservoir A can be measured with high precision. For example, a value (calculated value) may be used which is obtained by measuring a pressure of a solution distributing piping which distributes a coating solution to the supply flow path 24 by using a manometer, and subtracting a pressure drop at the supply flow path 24 from the measured value.

The pressure regulating device 19 regulates a pressure (kPa) of coating solution reservoir A which is measured by the pressure measuring device 17 based on a measurement result by the running speed measuring device 13. That is, a running speed V (m/min) of the web W measured by the running speed measuring device 13 and a pressure P (kPa) of the coating solution reservoir A measured by the pressure measuring device 17 are input into the pressure regulating device 19.

In case that the coating solution to be used has a larger contact angle of a liquid on a solid θ of the coating solution, in particular larger than 65°, the pressure regulating device 19 controls the pump P to regulate a volume of the coating solution to be discharged to the coating solution reservoir A so that the pressure satisfies a formula: P≧5V/8. This regulation of a pressure of the coating solution reservoir A can be performed by setting a volume of the coating solution to be discharged only at the starting time of the coating operation, and monitoring the pressure by checking if the pressure deviates from the formula after the setting. This allows even a coating solution having a low wettability (a degree of spread of a coating solution) to the web W due to a large contact angle (for example, 50 degrees or more) thereof to be applied to the web W at a high speed without causing any coating defects such as cracks in a resulting coating film.

The regulation of a pressure of the coating solution reservoir A is not limited to by the use of a pump P which adjusts a volume of the coating solution to be discharged to the coating solution reservoir A. For example, the bar supporting member 14 may be configured so that the top surface 14B can be advanced and retracted relative to the lower surface of the web W to change a volume of the coating solution reservoir A. That is, in order to increase a pressure (kPa) of the coating solution reservoir A, the top surface 14B of the bar supporting member 14 is advanced to the lower surface of the web W to reduce a volume of the coating solution reservoir A. In the example, it is preferable that a formula S/L≦0.15 mm is satisfied, where L is the coated width of the web W with the coating solution and S is the cut area of the coating solution reservoir A which is cut longitudinally in the running direction of the web, and surrounded by the web W, the shuttering board 16, the top surface 14B of the bar supporting member 14 and the coating bar 12. It is because the pressure is hardly given on the coating solution reservoir and becomes uneven when the cut area S is too large relative to the coated width L and the opening area of the coating solution reservoir becomes large.

Alternatively, the shuttering board 16 may be configured so that the top end 16A can be advanced and retracted relative to the lower surface of the web W to change a volume of the coating solution reservoir A. That is, in order to increase a pressure (kPa) of the coating solution reservoir A, the top end 16A of the shuttering board 16 is advanced to the lower surface of the web W to reduce a gap between the lower surface of the web W and the top end 16A of the shuttering board 16. This makes it uneasy for a coating solution to overflow out of the coating solution reservoir A into the reservoir of coating solution 28, which increases a pressure in the coating solution reservoir A.

In addition to the above, in order to increase a pressure (kPa) of the a coating solution reservoir A, the supply flow path 24 may be narrowed to increase a pressure to discharge a coating solution, or the coating bar 12 may have a smaller diameter to reduce a volume of the coating solution reservoir A.

The pressure of the coating solution reservoir A may be increased by using all of the volume of the coating solution reservoir A, the semi-tightness of the coating solution reservoir A, and the discharging pressure of a coating solution to be discharged to a coating solution reservoir A.

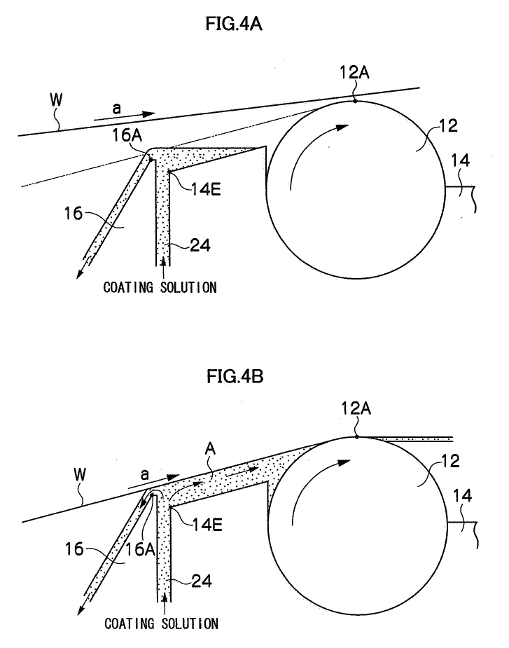

Next, an operation of the apparatus for applying a coating solution with a bar 10 which is configured as described above will be explained with reference to FIG. 4A and FIG. 4B.

As shown in FIG. 4A, before the start of coating, the web W and the coating bar 12 are disposed with a space between them. In this situation, the web W is caused to run in the direction a, the coating bar 12 is caused to rotate in the direction shown by an arrow, and a coating solution is discharged through the supply flow path 24. At this point, since the top end 16A of the shuttering board 16 is disposed at a position higher than the upstream upper end 14E of the coating bar supporting member 14, the coating solution discharged through the supply flow path 24 is stored in the discharge port of the supply flow path 24. Also, since the top end 16A of the shuttering board 16 is disposed at a position lower than the uppermost position 12A of the coating bar 12, the supplied coating solution overflows upstream over the top end 16A of the shuttering board 16.

Upon the start of coating, first, the base 18 is lifted (see FIG. 2). This gradually increases a wrap angle of the web W relative to the coating bar 12, and eventually the web W wraps the coating bar 12 as shown in chain double-dashed line of FIG. 4A. Then, the coating solution supplied through the supply flow path 24 is stored in the space surrounded by the shuttering board 16, the coating bar supporting member 14, the coating bar 12, and the web W to form the coating solution reservoir A as shown in FIG. 4B. When the space is filled with the coating solution, the internal pressure of the coating solution reservoir A is increased enough to start the application of the coating solution to the web W. Specifically, after most of the coating solution of the coating solution reservoir A is attached to the web W, the coating solution is moved with the web W along the running direction a of the web W to be scraped off by the coating bar 12. This makes a measured coating solution remained on the web W so that a coating solution having a predetermined thickness is applied to the web W.

In this coating using a bar, in the apparatus for applying a coating solution with a bar 10 of the present invention, a running speed of the web W is measured by the running speed measuring device 13, a pressure of the coating solution reservoir A is measured by the pressure measuring device 17, and the pressure of the coating solution reservoir A is regulated by the pressure regulating device based on the measurement values, which allows even a coating solution having a large contact angle (e.g., 50 degrees or more) to be applied at a high speed without causing any coating defects such as cracks in a resulting coating film.

### Second Embodiment

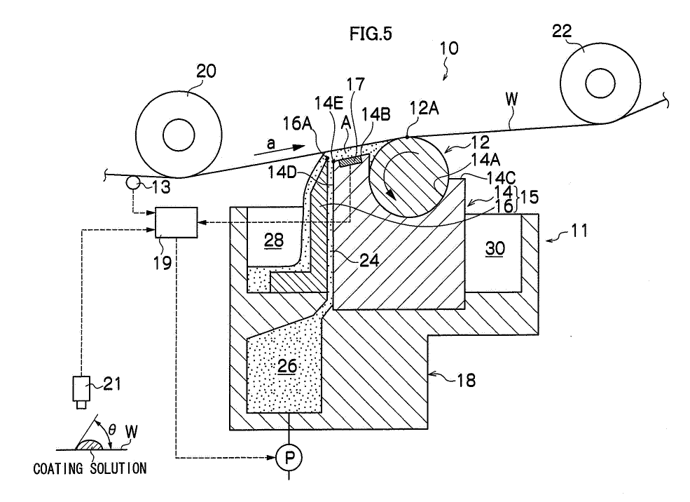

Next, a second embodiment of an apparatus for applying a coating solution with a bar according to the present invention will be explained with reference to FIG. 5.

An apparatus for applying a coating solution with a bar 10 of the second embodiment utilizes a contact angle of a liquid on a solid θ (degrees) of a coating solution as a factor to regulate a pressure (kPa) of a coating solution reservoir A, in addition to a running speed V (m/min) of a web W and a pressure P (kPa) of a coating solution reservoir A which are described in the first embodiment, and the other configuration of the second embodiment are the same as the first embodiment.

As shown in FIG. 5, the apparatus for applying a coating solution with a bar 10 includes contact angle measuring device 21 which is provided separately from a coating line thereof for off-line measuring a contact angle of a liquid on a solid θ (degrees) of a coating solution at the point of time when the coating solution contacts the static web W, and the contact angle of a liquid on a solid θ (degrees) measured by the contact angle measuring device 21 is input into the above described pressure regulating device 19.

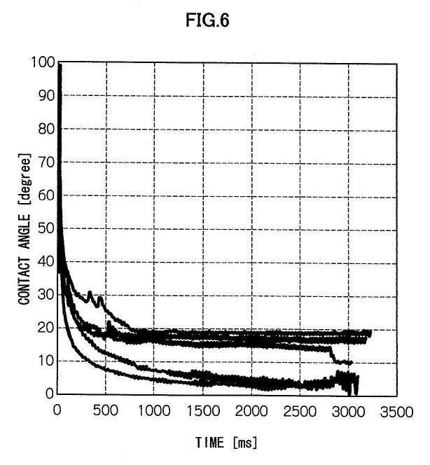

The contact angle measuring device 21 for measuring a contact angle of a liquid on a solid θ (degrees) of a coating solution may be, for example, a contact angle meter (DropMster series) manufactured by Kyowa Interface Science Co., LTD. That is, into the pressure regulating device 19, a running speed V (m/min) of a web W measured by the running speed measuring device 13, a pressure P (kPa) of a coating solution reservoir A measured by the pressure measuring device 17, and a contact angle of a liquid on a solid θ (degrees) of the coating solution measured by the contact angle measuring device 21 are input. The pressure regulating device 19 controls a pump P to regulate a volume of the coating solution discharged into the coating solution reservoir A so that the pressure of the coating solution reservoir A satisfies a formula: 0.5V≦50+P−θ. In this case, as shown in FIG. 6, after the coating solution is dropped onto the web W, a contact angle of the coating solution drop rapidly decreases over time to have a generally constant value. In the second embodiment of the present invention, it is critical to use a contact angle of a liquid on a solid θ (degrees) of the coating solution at the point of time (0 to 10 ms) when the coating solution is dropped onto the web W as a factor for regulating a pressure of the coating solution reservoir A. In addition, the apparatus may be configured that the contact angle of a liquid on a solid is measured on-line with high frequency and the feedback from the measured angle is given to the pressure control.

The above described regulation of a pressure of the coating solution reservoir A using a pump P is not the only way, and a pressure of the coating solution reservoir A may be regulated by other ways such as those described above for the first embodiment.

According to the apparatus for applying a coating solution with a bar 10 of the second embodiment, even when a coating solution having a large contact angle is applied to a web at such a high speed that an entrained air film may be formed on a surface of the web, the application is stable without causing coating defects such as cracks in a resulting coating film.

In the first and second embodiments of the present invention, the apparatus and method for applying a coating solution without causing coating defects such as cracks in a resulting coating film by increasing the pressure of the coating solution reservoir A are described. However, the example below is also applicable.

For example, the coating solution is discharged through the discharge port of the supply flow path 24 to the lower surface of the web W at the speeds of at least 2.5 m/min and not more than 50 m/min. In this way, the wall of the reservoir is formed between the discharge port of the supply flow path 24 and the lower surface of the web W, and thereby the pressure of the coating solution reservoir A is increased. In this example, it is possible to form the wall of the reservoir and to coat the coating solution through the coating solution reservoir by the coating solution from only one path of the supply flow path 24.

A taper face 16B to form the shuttering board 16 wedge shaped is formed on the shuttering board at the upper stream of the running direction of the web and the contact angle a of the taper face 16B and web W satisfies 45°≦α<90°. Therefore, a bead of the coating solution can be stably formed between the web W and the top end 16A of the shuttering board 16 and the coating solution in the coating solution reservoir A overflows onto the upper side of the web W through the bead. Thus, the pressure of the coating solution reservoir A can be increased by stably forming the bead and the pressure of the coating solution reservoir A can be stable by stably overflowing the coating solution.

### Third Embodiment

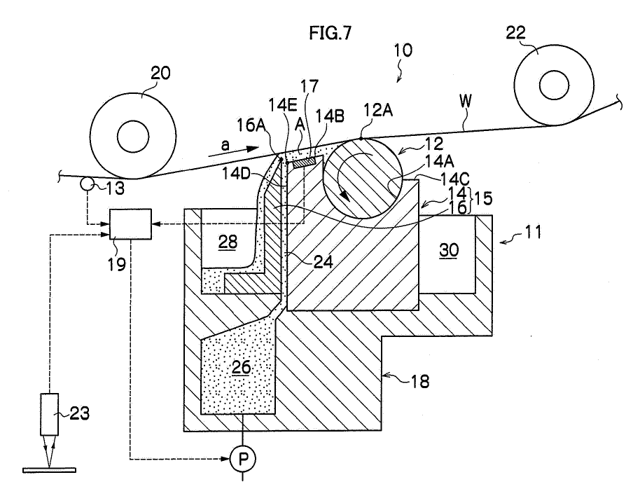

FIG. 7 is a view showing a structure of a third embodiment of an apparatus for applying a coating solution with a bar according to the present invention.

As shown in FIG. 7, the third embodiment of an apparatus for applying a coating solution with a bar according to the present invention is similar to the first embodiment which is described by reference to FIG. 1 and FIG. 2, except that the third embodiment is provided with a surface roughness measuring device 23. Other structures of the third embodiment are the same as those of the first embodiment, and will not be described below.

That is, an apparatus for applying a coating solution with a bar 10 of the third embodiment generally includes a main body of the apparatus 11, a running speed measuring device 13 for measuring a running speed of a web W, a pressure measuring device 17 for measuring a pressure of the coating solution reservoir A, a surface roughness measuring device 23 for measuring a surface roughness of a web (center line average roughness) Ra, and a pressure regulating device 19 for regulating a pressure P of the coating solution reservoir A which is measured by the pressure measuring device 17 based on the measurement results measured by the running speed measuring device 13 and the surface roughness measuring device 23.

The surface roughness measuring device 23 may be any laser-type non-contacting measuring device or any contact-type contacting measuring device which are able to measure a web surface roughness Ra on the order of 0.01 μm, and for example, SURFCOM Series manufactured by Tokyo Seimitsu Co., Ltd. may be preferably used. A surface roughness Ra of the web W may measured off-line as shown in FIG. 7 by cutting a part of the web W, or may be measured on-line.

The pressure regulating device 19 regulates a pressure of the coating solution reservoir A (kPa) which is measured by the pressure measuring device 17, based on the measurement results measured by the running speed measuring device 13 and the surface roughness measuring device 23. That is, the pressure regulating device 19 receives the data of a running speed V of the web W (m/min) measured by the running speed measuring device 13, a surface roughness Ra (μm) of the web W measured by the surface roughness measuring device 23, and a pressure P of the coating solution reservoir A (kPa) measured by the pressure measuring device 17. Then the pressure regulating device 19 controls a pump P to regulate an amount of the coating solution which is discharged to the coating solution reservoir A, and a pressure of the coating solution reservoir A so that a formula: 0.5V≦40+P−50Ra is satisfied. The regulation of a pressure of the coating solution reservoir A can be performed by setting an amount of the coating solution to be discharged only at the beginning of a coating operation, and only monitoring the pressure after the setting whether the pressure deviates from the formula: 0.5V≦40+P−50Ra or not. The formula: 0.5V≦40+P−50Ra is particularly preferred when θ≦50 (degree) is satisfied, where θ is a contact angle of a liquid on a solid of the coating solution in degree.

This prevents any coating defects such as cracks in a resulting coating film even when a coating solution is applied at a high speed of 60 m/min or more to a web W which has a large surface roughness Ra and tends to generate an entraining air flow. For such a coating at a high speed, a pressure of the coating solution reservoir A is regulated to be increased.

According to the third embodiment of an apparatus for applying a coating solution with a bar 10 of the present invention which is configured as described above, since a running speed of a web W is measured by the running speed measuring device 13, a surface roughness of the web W is measured by the surface roughness measuring device 23, and a pressure of the coating solution reservoir A is measured by the pressure measuring device 17 respectively, and the pressure regulating device 19 regulates (usually increases) the pressure of the coating solution reservoir A based on the measured values, an application of a coating solution at a high speed of 60 m/min or more to a web W which has a large surface roughness and tends to generate an entraining air flow can be achieved in a stable manner without causing any coating defects such as such cracks in a resulting coating film.

When a web W having a large surface roughness is used to coat a film at a high speed, as the web W runs, an entraining air flow is likely brought in the coating solution reservoir A, which causes the coating defects such as such cracks in a resulting coating film. Therefore, a decompressor may be arranged upstream of the shuttering board 16 to suck the entraining air flow.

### Fourth Embodiment

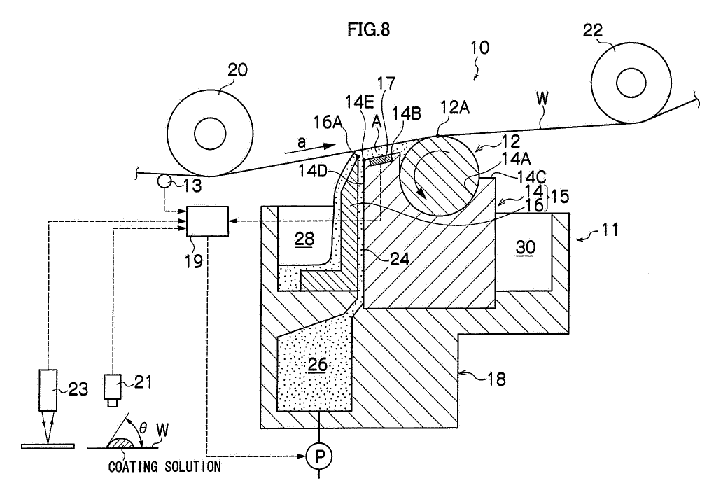

FIG. 8 is a view showing a structure of a fourth embodiment of an apparatus for applying a coating solution with a bar according to the present invention.

As shown in FIG. 8, the fourth embodiment of an apparatus for applying a coating solution with a bar according to the present invention is configured to regulate a pressure of the coating solution reservoir A (kPa) by using factors including a running speed V of the web W (m/min), a surface roughness Ra of the web W (μm), and a pressure P of the coating solution reservoir A (kPa) (which are described in the third embodiment), as well as a contact angle of a liquid on a solid of the coating solution θ (degree) (which is described in the second embodiment). Other structures of the fourth embodiment are the same as those of the above described embodiments.

That is, an apparatus for applying a coating solution with a bar 10 of a fourth embodiment generally includes a main body of the apparatus 11, a running speed measuring device 13 for measuring a running speed of the web W, a pressure measuring device 17 for measuring a pressure of the coating solution reservoir A, a surface roughness measuring device 23 for measuring a surface roughness of a web (center line average roughness) Ra, a contact angle measuring device 21 for measuring a contact angle of a liquid on a solid of the coating solution θ (degree) off-line at the point of time when the coating solution contacts the static web W, and a pressure regulating device 19 for regulating a pressure P of the coating solution reservoir A which is measured by the pressure measuring device 17 based on the measurement results measured by the running speed measuring device 13, the surface roughness measuring device 23, and the contact angle measuring device 21.

As shown in FIG. 8, separately from the coating line of the apparatus for applying a coating solution with a bar 10, a contact angle measuring device 21 for measuring a contact angle of a liquid on a solid of the coating solution θ off-line at the point of time when the coating solution contacts the static web W (degree) is provided, and a contact angle of a liquid on a solid θ (degree) measured by the contact angle measuring device 21 is input to the pressure regulating device 19.

The contact angle measuring device 21 for measuring a contact angle of a liquid on a solid of the coating solution θ (degree) may be a contact angle meter (DropMaster Series) manufactured by Kyowa Interface Science Co., Ltd. for example, as in the case with the second embodiment. A contact angle of a liquid on a solid of the coating solution θ (degree) is measured at room temperature.

That is, the pressure regulating device 19 receives the data of a running speed V of the web W (m/min) measured by the running speed measuring device 13, a pressure P of the coating solution reservoir A (kPa) measured by the pressure measuring device 17, a surface roughness Ra (μm) of the web W measured by the surface roughness measuring device 23, and a contact angle of a liquid on a solid of the coating solution θ (degree) measured by the contact angle measuring device 21. Then the pressure regulating device 19 controls a pump P to regulate an amount of the coating solution which is discharged to the coating solution reservoir A so that a formula: 0.5V≦90+P−50Ra is satisfied. In this case, as shown in FIG. 6, after the coating solution is dropped onto the web W, as time goes, the contact angle of the coating solution rapidly decreases to be a generally constant value. In the fourth embodiment of the present invention, it is critical to use the contact angle of a liquid on a solid θ at the point of time (0 to 10 ms) when the coating solution is dropped and contacts the web W, as a factor for regulating a pressure of the coating solution reservoir A.

The regulation of a pressure of the coating solution reservoir A (kPa) is not limited to the method by means of an amount of a coating solution discharged by a pump P, but a pressure of the coating solution reservoir A (kPa) may be regulated by any method other than that described above.

According to the fourth embodiment of an apparatus for applying a coating solution with a bar 10, an application of a coating solution at a high speed of 60 m/min or more to a web W which has a large surface roughness and has a low wettability to the coating solution can be achieved in a stable manner without causing any coating defects such as such cracks in a resulting coating film.

### EXAMPLE

### Example 1

In Example 1 of the present invention, an apparatus for applying a coating solution with a bar 10 of FIGS. 1 and 2 was used, and also a contact angle of a liquid on a solid θ is set constant. And it is an test for examining a relationship between a running speed V (m/min) of a web W and a pressure P (kPa) of a coating solution reservoir A when a lithographic printing plate is manufactured by applying four coating solutions for photosensitive layers which have large contact angles θ (degrees) on the web W. While the web W was maintained under a tension of 100 kg/m, the coating bar 12 was caused to rotate at a speed of 5 rpm in a direction which is opposite to that of the running direction a of the web W (see FIG. 1) for application of the coating solution. The running speed V (m/min) of the web W was within a range of 60 to 140 (m/min) for a high speed application, and the pressure of the coating solution reservoir A was regulated using a pump P which regulated a volume of the coating solution to be discharged.

The web W was made by grinding a surface of an aluminum web having a width of 1 m, and performing an anodic oxidation processing over the surface. Four coating solutions for photosensitive layers A to D having large contact angles of a liquid on a solid θ were prepared by solving a photosensitive material, a binder, a dye, and a thickener in an organic solvent, and adding a surfactant of different quantities for each solution.

The contact angles of a liquid on a solid θ of the coating solution for photosensitive layers A to D were measured by a contact angle meter (DropMaster 700) manufactured by Kyowa Interface Science Co., LTD to obtain results as follows. In addition, a surface roughness Ra of a web W to be used is 0.8 μm.
A contact angle of a liquid on a solid θ of the coating solution for photosensitive layers A . . . 40 (degrees)
A contact angle of a liquid on a solid θ of the coating solution for photosensitive layers B . . . 50 (degrees)
A contact angle of a liquid on a solid θ of the coating solution for photosensitive layers C . . . 65 (degrees)
A contact angle of a liquid on a solid θ of the coating solution for photosensitive layers D . . . 70 (degrees)

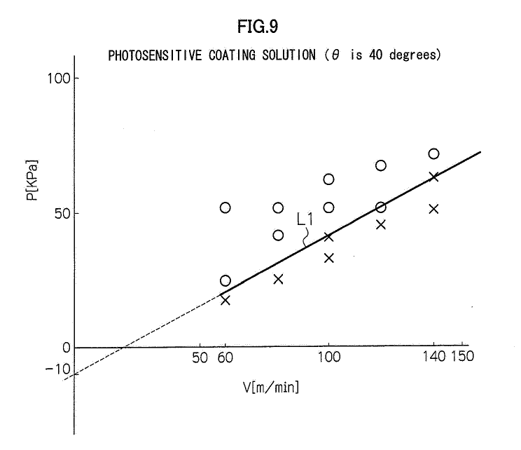

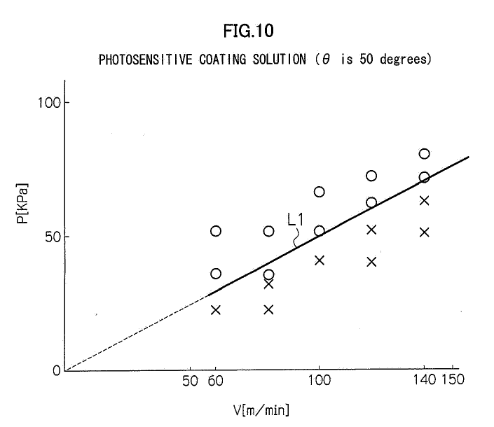

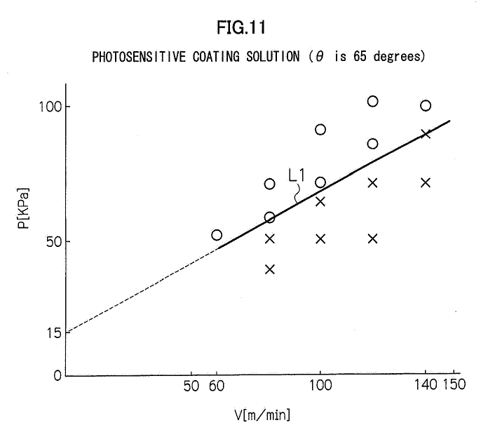

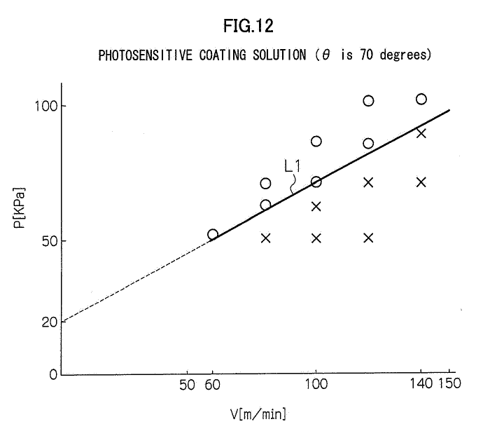

As for the coating solution for photosensitive layers A, a relationship between a running speed V (m/min) of the web W and a pressure P (kPa) of the coating solution reservoir A was examined to obtain a test result, which is shown in FIG. 9. As for the coating solution for photosensitive layers B, a relationship between a running speed V (m/min) of the web W and a pressure P (kPa) of the coating solution reservoir A was examined to obtain a test result, which is shown in FIG. 10. As for the coating solution for photosensitive layers C, a relationship between a running speed V (m/min) of the web W and a pressure P (kPa) of the coating solution reservoir A was examined to obtain a test result, which is shown in FIG. 11. As for the coating solution for photosensitive layers D, a relationship between a running speed V (m/min) of the web W and a pressure P (kPa) of the coating solution reservoir A was examined to obtain a test result, which is shown in FIG. 12.

In FIG. 9 to FIG. 12, the marks of a circle show the cases where the coating solution was applied well without any coating defects such as cracks in a resulting coating film, while the marks of a cross show the cases where an entrained air entered in the coating solution reservoir A which caused coating defects such as cracks in a resulting coating film.

As shown in FIG. 9 to FIG. 12, in all of the cases using the coating solutions for photosensitive layers A to D, the coating solutions were applied well in the region above a straight line L1, and cracks in a resulting coating film were caused in the region below the straight line L1.

As seen from the above results, even when a coating solution having a large contact angle θ is applied to a web at such a high speed that an entrained air film may be formed on a surface of the web, the application can be stable without causing coating defects such as cracks in a resulting coating film by regulating a pressure of the coating solution reservoir A so that the pressure satisfies the straight line L1.

As seen from FIG. 9 to FIG. 12, the straight line L1 has the same gradient even when a coating solution for photosensitive layers has a different contact angle of a liquid on a solid θ, but for a coating solution for photosensitive layer which has a larger contact angle of a liquid on a solid θ, the straight line L1 is shifted (translated) upward (to a region where a pressure is higher), and for a coating solution for photosensitive layer which has a smaller contact angle of a liquid on a solid θ, the straight line L1 is shifted (translated) downward (to a region where a pressure is lower). That is, since the straight line L1 is shifted by about ±10 (kPa) across the origin 0 depending on a pressure value, a compensation of the straight line L, within a range of ±10 (kPa) corresponding to a contact angle of a liquid on a solid θ of the photosensitive layer can further enhance the precision in applying a coating solution.

### Example 2

In Example 2 of the present invention, since it became clear that the contact angle of a liquid on a solid θ influenced a stable application of a coating solution, an apparatus for applying a coating solution with a bar 10 of FIG. 5 was used to examine a relationship between three factors of a contact angle of a liquid on a solid θ of a coating solution, a running speed V (m/min) of a web W, and a pressure P (kPa) of a coating solution reservoir A when a lithographic printing plate is manufactured by applying the above four coating solutions for photosensitive layers A, B, C, D which have contact angles θ (degrees) of 40 (degrees), 50 (degrees), 65 (degrees), and 70 (degrees) respectively. Six samples were made for the coating solution having a contact angle θ of 40 (degrees), six samples were made for the coating solution having a contact angle θ of 50 (degrees), ten samples were made for the coating solution having a contact angle θ of 65 (degrees), and ten samples were made for the coating solution having a contact angle θ of 70 (degrees). Other condition of Example 2 was the same as that of Example 1. In addition, a surface roughness Ra of a web W to be used is 0.8 μm.

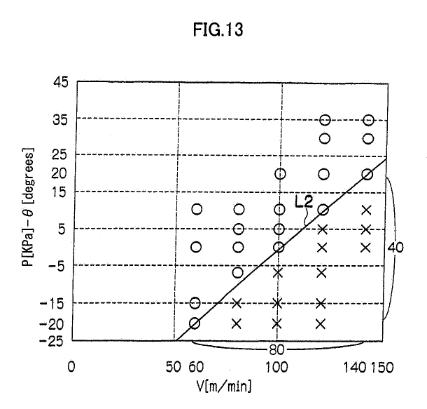

The test results of Example 2 are shown in FIG. 13. As shown in FIG. 13, in all of the cases using the four coating solutions for photosensitive layers which had a contact angle θ (degrees) of 40 (degrees), 50 (degrees), 65 (degrees), and 70 (degrees) respectively, the coating solutions were applied well in the region above a straight line L2 which is represented by an equation: 0.5V =50+P−θ, and cracks in a resulting coating film were caused in the region below the straight line L2. As seen from the results, even when a coating solution having a different contact angle θ is applied to a web at such a high speed that an entrained air film may be formed on a surface of the web, the application can be stable without causing coating defects such as cracks in a resulting coating film by regulating a pressure of the coating solution reservoir A so that the pressure satisfies a formula: 0.5V≦50+P−θ.

### Example 3

Example 3 of the present invention is a test to examine the relationship between a running speed V of the web W (m/min), a surface roughness Ra of a web W (μm), and a pressure P of the coating solution reservoir A (kPa), in manufacturing a planographic printing plate by coating a coating solution for a photosensitive layer to the web W and drying the coated film, using the apparatus for applying a coating solution with a bar 10 of FIG. 7.

(Coating Solution)

A coating solution for photosensitive layer was prepared by solving a photosensitive material, a binder, a dye, and a thickener into an organic solvent, and adding a surfactant to obtain a coating solution having a contact angle of a liquid on a solid θ of 50 degrees. A contact angle of a liquid on a solid θ of the coating solution for photosensitive layer was measured by a contact angle meter (DropMaster 700) manufactured by Kyowa Interface Science Co., Ltd.

(Web)

The web W was an aluminum web having a width of 1 m on which an anodic oxide film was formed. In order to check coating states due to the difference between surface roughness Ra of webs, six strips of webs each of which had a different surface roughness Ra were used as follows.
Web A having a surface roughness Ra of 0.01 (μm)
Web B having a surface roughness Ra of 0.1 (μm)
Web C having a surface roughness Ra of 0.2 (μm)
Web D having a surface roughness Ra of 0.4 (μm)
Web E having a surface roughness Ra of 0.8 (μm)
Web F having a surface roughness Ra of 1.0 (μm)
   (Test of Manufacturing Planographic Printing Plate)

The above coating solution was applied to the above listed six strips of webs each of which had a different surface roughness, by applying a tension of 100 kg/m, and rotating the coating bar 12 at a speed of 5 rpm in the direction opposite to the running direction a of the web W (see FIG. 8).

A running speed V of the web W was in the high speed coating range of 60 to 140 (m/min), and a pressure of the coating solution reservoir A was regulated by regulating an amount of the discharged coating solution by using a pump P. The coated solution was dried by a drying air which was sent vertically to the coated film surface from a plurality of nozzles that were arranged along the web running direction. The nozzles had a slit width of 2 mm, and were spaced from each other by a distance of 150 mm. The drying air was sent at a speed of 10 m/sec, and had a temperature of 150 degree. C.

(Test Results)

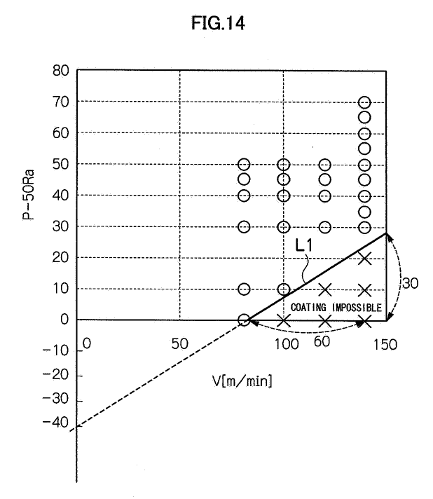

The results of the test of manufacturing planographic printing plate which was conducted under the condition described above are shown in Table 1 and FIG. 14. FIG. 14 is a plotted graph for deriving a formula between a running speed V of the web W, a surface roughness Ra of the web W, and a pressure P of the coating solution reservoir A from the result of Table 1. The L.S. in Table 1 means a coating speed.

TABLE 1

| | | Solution | Surface | |
|---|---|---|---|---|
| Run- | L.S. | pressure | roughness | Surface state for |
| No. | [m/min] | P [kPa] | Ra [μm] | coating |
| 1 | 80 | 50 | 0.01 | O.K. |
| 2 | 80 | 50 | 0.1 | O.K. |
| 3 | 80 | 50 | 0.2 | O.K. |
| 4 | 80 | 50 | 0.4 | O.K. |
| 5 | 80 | 50 | 0.8 | O.K. |
| 6 | 80 | 50 | 1 | O.K. |
| 7 | 100 | 50 | 0.01 | O.K. |
| 8 | 100 | 50 | 0.1 | O.K. |
| 9 | 100 | 50 | 0.2 | O.K. |
| 10 | 100 | 50 | 0.4 | O.K. |
| 11 | 100 | 50 | 0.8 | O.K. |
| 12 | 100 | 50 | 1 | Coating was impossible |
| 13 | 120 | 50 | 0.01 | O.K. |
| 14 | 120 | 50 | 0.1 | O.K. |
| 15 | 120 | 50 | 0.2 | O.K. |
| 16 | 120 | 50 | 0 4 | O.K. |
| 17 | 120 | 50 | 0.8 | Coating was impossible |
| 18 | 120 | 50 | 1 | Coating was impossible |
| 19 | 140 | 50 | 0.01 | O.K. |
| 20 | 140 | 50 | 0.1 | O.K. |
| 21 | 140 | 50 | 0.2 | O.K. |
| 22 | 140 | 50 | 0.4 | O.K. |
| 23 | 140 | 50 | 0.8 | Coating was impossible |
| 24 | 140 | 50 | 1 | Coating was impossible |
| 25 | 140 | 70 | 0.01 | O.K. |
| 26 | 140 | 70 | 0.1 | O.K. |
| 27 | 140 | 70 | 0.2 | O.K. |
| 28 | 140 | 70 | 0.4 | O.K. |
| 29 | 140 | 70 | 0.8 | O.K. |
| 30 | 140 | 70 | 1 | Coating was impossible |

In FIG. 14, each of the marks of a circle shows a good coating without coating defects such as cracks in a resulting coating film, while each of the marks of a cross shows a poor coating with coating defects such as cracks in a resulting coating film due to an entraining air brought into the coating solution reservoir A.

As shown in FIG. 14, a straight line L1 represents equation, P−50Ra=0.5V−40, and the area above the straight line L1 includes the good coatings. By using the straight line L1, a formula: 0.5V≦40+P−50Ra can be derived. That is, in any case where the webs A to F having a different surface roughness are used, the good coatings could be obtained in the area above the straight line L1 which represents a formula: 0.5V≦40+P−50Ra, and cracks were formed in a resulting coating film in the area below the straight line L1.

The above results show that even an application of a coating solution at a high speed of 60 m/min or more (60 to 140 m/min) to a web W having a large surface roughness and tends to generate an entraining air flow can be achieved in a stable manner without coating defects such as cracks in a resulting coating film.

### Example 4

Example 4 of the present invention is a test to examine the relationship between a running speed V of the web W (m/min), a surface roughness Ra of a web W (μm), and a pressure P of the coating solution reservoir A (kPa) like Example 3, and also to examine a change of coatability when a web having a low wettability to a coating solution is used, by using the apparatus for applying a coating solution with a bar 10 of FIG. 8.

In order to test the wettability to a web, four coating solutions for photosensitive layer A, B, C, D were used. The coating solutions were prepared by adding a different amount of a surfactant, and had a contact angle of a liquid on a solid θ (degree) of 40, 50, 65, and 70, respectively.

(Test Results)

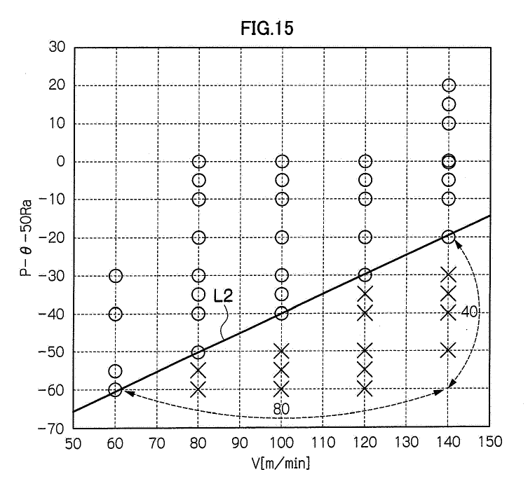

The results of the test of manufacturing planographic printing plate which was conducted under the condition described above are shown in FIG. 15. FIG. 15 is a plotted graph which is obtained by combining the results shown in Table 1 of Example 3 with the test results shown in Table 2 with the use of the coating solutions having a contact angle of a liquid on a solid θ (degree) of 40, 50, 65, and 70, respectively.

TABLE 2

| | | Solution | | |
|---|---|---|---|---|
| Run | L.S. | pressure | Coating | Surface state for |
| No. | [m/min] | P [kPa] | solution | coating |
| 1 | 60 | 50 | A | O.K. |
| 2 | 60 | 50 | B | O.K. |
| 3 | 60 | 50 | C | O.K. |
| 4 | 60 | 50 | D | O.K. |
| 5 | 80 | 50 | A | O.K. |
| 6 | 80 | 50 | B | O.K. |
| 7 | 80 | 50 | C | Coating was impossible |
| 8 | 80 | 50 | D | Coating was impossible |
| 9 | 80 | 70 | C | O.K. |
| 10 | 80 | 70 | D | O.K. |
| 11 | 100 | 50 | A | O.K. |
| 12 | 100 | 50 | B | O.K. |
| 13 | 100 | 50 | C | Coating was impossible |
| 14 | 100 | 50 | D | Coating was impossible |
| 15 | 100 | 70 | C | O.K. |
| 16 | 100 | 70 | D | O.K. |
| 17 | 120 | 50 | A | O.K. |
| 18 | 120 | 50 | B | Coating was impossible |
| 19 | 120 | 50 | C | Coating was impossible |
| 20 | 120 | 50 | D | Coating was impossible |
| 21 | 120 | 70 | B | O.K. |
| 22 | 120 | 70 | C | Coating was impossible |
| 23 | 120 | 70 | D | Coating was impossible |
| 24 | 120 | 100 | C | O.K. |
| 25 | 120 | 100 | D | O.K. |
| 26 | 140 | 50 | A | Coating was impossible |
| 27 | 140 | 70 | A | O.K. |
| 28 | 140 | 70 | B | O.K. |
| 29 | 140 | 70 | C | Coating was impossible |
| 30 | 140 | 70 | D | Coating was impossible |
| 31 | 140 | 100 | C | O.K. |
| 32 | 140 | 100 | D | O.K. |

As shown in FIG. 15, a straight line L2 represents equation, P−θ−50Ra=0.5V−90, and the area above the straight line L2 includes the good coatings. By using the straight line L2, a formula: 0.5V≦90+P−θ−50Ra can be derived. In FIG. 15, the y-intercept value is −65 because the x axis starts with a value 50.

That is, when a condition of a contact angle of a liquid on a solid was added to the conditions of Example 3, in any case where four coating solutions for photosensitive layer having different contact angles θ (degree) of 40, 50, 65, and 70, the good coatings could be obtained in the area above the straight line L2 which represents a formula: 0.5V ≦90+P−θ−50Ra, and cracks were formed in a resulting coating film in the area below the straight line L2.

The above results show that even an application of a coating solution at a high speed of 60 m/min or more (60 to 140 m/min) to a web W having a large surface roughness and a low wettability to a coating solution can be achieved in a stable manner without coating defects such as cracks in a resulting coating film.

What is claimed is:

1. A method for applying a coating solution with a bar, comprising the steps of:
contacting a rotating coating bar with a lower surface of a continuously running web;
discharging a coating solution toward the lower surface of the web from a coating solution discharging section positioned upstream of the coating bar in a web running direction to form a coating solution reservoir upstream of the coating bar; and
applying the coating solution to the web via the coating solution reservoir, wherein
the method for applying a coating solution with a bar includes a step of regulating a pressure of the coating solution reservoir depending on a running speed of the web.

2. A method for applying a coating solution with a bar, comprising the steps of:
contacting a rotating coating bar with a lower surface of a continuously running web;
discharging a coating solution toward the lower surface of the web from a coating solution discharging section positioned upstream of the coating bar in a web running direction to form a coating solution reservoir upstream of the coating bar; and
applying the coating solution to the web via the coating solution reservoir, wherein
the method for applying a coating solution with a bar includes a step of regulating a pressure of the coating solution reservoir to satisfy a formula: 0.5V≦50+P−θ, where V is a running speed of the web in m/min, P is a pressure of the coating solution reservoir in kPa, and θ is a contact angle of a liquid on a solid of the coating solution in degrees.

3. A method for applying a coating solution with a bar, comprising the steps of:
contacting a rotating coating bar with a lower surface of a continuously running web;
discharging a coating solution toward the lower surface of the web from a coating solution discharging section positioned upstream of the coating bar in a web running direction to form a coating solution reservoir upstream of the coating bar; and
applying the coating solution to the web via the coating solution reservoir, wherein
the method for applying a coating solution with a bar further includes a step of regulating a pressure of the coating solution reservoir to satisfy a formula: 0.5V≦40+P−50Ra, where V is a running speed of the web in m/min, P is a pressure of the coating solution reservoir in kPa, and Ra is a surface roughness of the lower surface of the web in μm.

4. A method for applying a coating solution with a bar, comprising the steps of:
contacting a rotating coating bar with a lower surface of a continuously running web;
discharging a coating solution toward the lower surface of the web from a coating solution discharging section positioned upstream of the coating bar in a web running direction to form a coating solution reservoir upstream of the coating bar; and
applying the coating solution to the web via the coating solution reservoir, wherein
the method for applying a coating solution with a bar further includes a step of regulating a pressure of the coating solution reservoir to satisfy a formula: 0.5V≦90+P−θ−50Ra, where V is a running speed of the web in m/min, P is a pressure of the coating solution reservoir in kPa, θ is a contact angle of a liquid on a solid of the coating solution in degree, and Ra is a contact angle of the lower surface of the web in μm.

5. The method for applying a coating solution with a bar according to claim 1, wherein
the running speed of the web V is 60 or more in m/min.

6. The method for applying a coating solution with a bar according to claim 2, wherein
the running speed of the web V is 60 or more in m/min.

7. The method for applying a coating solution with a bar according to claim 3, wherein
the running speed of the web V is 60 or more in m/min.

8. The method for applying a coating solution with a bar according to claim 4, wherein
the running speed of the web V is 60 or more in m/min.

9. The method for applying a coating solution with a bar according to claim 1, wherein
the pressure of the coating solution reservoir is regulated by changing a volume of the coating solution reservoir.

10. The method for applying a coating solution with a bar according to claim 2, wherein
the pressure of the coating solution reservoir is regulated by changing a volume of the coating solution reservoir.

11. The method for applying a coating solution with a bar according to claim 3, wherein
the pressure of the coating solution reservoir is regulated by changing a volume of the coating solution reservoir.

12. The method for applying a coating solution with a bar according to claim 4, wherein
the pressure of the coating solution reservoir is regulated by changing a volume of the coating solution reservoir.

13. The method for applying a coating solution with a bar according to claim 1, wherein
the pressure of the coating solution reservoir is regulated by changing a volume of the coating solution which is discharged from the coating solution discharging section.

14. The method for applying a coating solution with a bar according to claim 2, wherein
the pressure of the coating solution reservoir is regulated by changing a volume of the coating solution which is discharged from the coating solution discharging section.

15. The method for applying a coating solution with a bar according to claim 3, wherein
the pressure of the coating solution reservoir is regulated by changing a volume of the coating solution which is discharged from the coating solution discharging section.

16. The method for applying a coating solution with a bar according to claim 4, wherein
the pressure of the coating solution reservoir is regulated by changing a volume of the coating solution which is discharged from the coating solution discharging section.

17. A method for manufacturing a coating film product, comprising the step of manufacturing a coating film product using the method for applying a coating solution with a bar according to claim 1.

18. A method for manufacturing a coating film product, comprising the step of manufacturing a coating film product using the method for applying a coating solution with a bar according to claim 2.

19. A method for manufacturing a coating film product, comprising the step of manufacturing a coating film product using the method for applying a coating solution with a bar according to claim 3.

20. A method for manufacturing a coating film product, comprising the step of manufacturing a coating film product using the method for applying a coating solution with a bar according to claim 4.

21. The method for manufacturing a coating film product according to claim 17, wherein
the coating film product is a lithographic printing plate which has a photosensitive layer thereon as a coating film.

22. The method for manufacturing a coating film product according to claim 20, wherein
the coating film product is a lithographic printing plate which has a photosensitive layer thereon as a coating film.

23. An apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, comprising:
a running speed measuring device for measuring a running speed of the web;
a pressure measuring device for measuring a pressure of the coating solution reservoir; and
a pressure regulating device for regulating the pressure of the coating solution reservoir measured by the pressure measuring device based on a measurement result by the running speed measuring device.

24. The apparatus for applying a coating solution with a bar according to claim 23, further comprising:
a contact angle measuring device for measuring a contact angle of the coating solution at the point of time (0 to 10 ms) when the coating solution contacts the web; and
the pressure regulating device regulates the pressure of the coating solution reservoir so that the pressure satisfies a formula: 0.5V≦50+P−θ, where V is a running speed of the web measured by the running speed measuring device in m/min, P is a pressure of the coating solution reservoir measured by the pressure measuring device in kPa, and θ is a contact angle of a liquid on a solid of the coating solution which is measured by the contact angle measuring device in advance.

25. An apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, comprising:
a running speed measuring device for measuring a running speed of the web;
a pressure measuring device for measuring a pressure of the coating solution reservoir;
a surface roughness measuring device for measuring a surface roughness of the lower surface of the web; and
a pressure regulating device for regulating the pressure of the coating solution reservoir measured by the pressure measuring device based on the measurement results measured by the running speed measuring device and the surface roughness measuring device.

26. The apparatus for applying a coating solution with a bar according to claim 25, wherein
the pressure regulating device regulates the pressure P of the coating solution reservoir so that the pressure P satisfies a formula: 0.5V≦40+P−50Ra, where V is a running speed of the web in m/min, P is a pressure of the coating solution reservoir in kPa, and Ra is a surface roughness of the lower surface of the web in μm.

27. The apparatus for applying a coating solution with a bar according to claim 26, wherein
a formula θ≦50 is satisfied, where θ is a contact angle of a liquid on a solid of the coating solution in degree.

28. An apparatus for applying a coating solution with a bar, having a rotating coating bar which is brought in contact with a lower surface of a continuously running web, and a coating solution discharging section positioned upstream of the coating bar in a web running direction from which a coating solution is discharged toward the lower surface of the web for forming a coating solution reservoir upstream of the coating bar and applying the coating solution to the web via the coating solution reservoir, comprising:
a running speed measuring device for measuring a running speed of the web;
a pressure measuring device for measuring a pressure of the coating solution reservoir;
a surface roughness measuring device for measuring a surface roughness of the lower surface of the web;
a contact angle measuring device for measuring a contact angle of the web to the coating solution at the point of time (0 to 10 ms) when the coating solution contacts the web; and
a pressure regulating device for regulating the pressure of the coating solution reservoir measured by the pressure measuring device based on the measurement results measured by the running speed measuring device, the surface roughness measuring device, and the contact angle measuring device.

29. The apparatus for applying a coating solution with a bar according to claim 28, wherein
the pressure regulating device regulates the pressure of the coating solution reservoir so that the pressure satisfies a formula: 0.5V≦90+P−θ−50Ra, where V is a running speed of the web in m/min, P is a pressure of the coating solution reservoir in kPa, and θ is a contact angle of a liquid on a solid of the coating solution in degree, and Ra is a surface roughness of the lower surface of the web in μm.
